(19) United States
(12) Patent Application Publication
(10) Pub. No.: US 2026/0070801 A1
(43) Pub. Date: Mar. 12, 2026

(54) RECOVERY SYSTEM FOR PREPARING MAGNESIUM SULFATE FROM SULFURIC ACID WASTE SOLUTION AND METHOD THEREOF

(71) Applicant: MG CHEM CO., LTD., Tainan City (TW)

(72) Inventor: I Jen Hsiao, Tainan City (TW)

(21) Appl. No.: 19/325,921

(22) Filed: Sep. 11, 2025

(30) Foreign Application Priority Data
Sep. 11, 2024 (TW) 113209917

(51) Int. Cl. C01F 5/40; B01D 9/00; B01D 25/12; F26B 3/092; F26B 21/10

(52) U.S. Cl. CPC C01F 5/40; B01D 9/0004; B01D 25/12; F26B 21/35; B01D 2009/0086; F26B 3/0923

(57) ABSTRACT

A recovery system for preparing magnesium sulfate from sulfuric acid waste solution is disclosed. The system comprises a reactor configured to remove hydrogen peroxide from the sulfuric acid waste solution and to promote a reaction between the sulfuric acid waste solution and a magnesium-based neutralizing agent to form a magnesium sulfate solution, a crystallization device configured to cool the magnesium sulfate solution and continuously crystallize magnesium sulfate crystals and a crystallization mother liquor, a dewatering device configured to separate the crystallization mother liquor from the magnesium sulfate crystals, and a drying device configured to obtain magnesium sulfate hydrates containing 0 to 7 molecules of crystalline water by controlling a drying temperature. A method for preparing magnesium sulfate using the recovery system is also disclosed.

### FIELD OF INVENTION

The present invention relates to the field of waste solution recovery technologies, and more particularly to a recovery system for preparing magnesium sulfate from sulfuric acid waste solution and a method thereof.

### BACKGROUND OF THE INVENTION

Sulfuric acid is one of the most widely used acids in industrial production. In the context of the circular economy, the treatment and reutilization of waste sulfuric acid solutions generated during production has become a matter of critical industrial importance. Taiwan's semiconductor manufacturing industry has experienced rapid growth, and since semiconductor wafers are highly sensitive to micro-contaminants, multiple cleaning steps are required to achieve contamination-free wafer surfaces.

At present, wet clean process is the mainstream wafer cleaning technology, in which large quantities of mixed solutions of sulfuric acid and hydrogen peroxide are employed. After wafer cleaning, the resulting waste solution contains reduced concentrations of sulfuric acid and hydrogen peroxide, rendering it unsuitable for direct reuse in semiconductor production. Consequently, large volumes of waste sulfuric acid are generated. Owing to its high concentration, such waste sulfuric acid could theoretically still serve as a raw material for the steel and metal industries; however, the presence of residual hydrogen peroxide induces undesirable side reactions, leading to increased raw material consumption and reduced utilization efficiency. Furthermore, the overall output of waste sulfuric acid across industries greatly exceeds domestic demand, creating an urgent need for new and robust recycling pathways to address the issue of excessive waste sulfuric acid.

Magnesium sulfate, by contrast, possesses broad market utility across a wide range of industrial fields, including electroplating, environmental protection, construction materials, fire-retardant materials, man-made fibers, papermaking, leather tanning agents, magnesium stearate production, and numerous others. It also has significant agricultural applications, being widely employed in fertilizers and animal feed, and thus represents a product with substantial development potential.

Accordingly, there is an urgent need to remove impurities from the waste sulfuric acid generated by the domestic semiconductor manufacturing industry and convert it into magnesium sulfate of various grades to meet market demand. Achieving this goal would not only advance the objectives of circular economy but also contribute to energy conservation and carbon reduction.

### SUMMARY OF THE INVENTION

A primary objective of the present invention is to provide a recovery system for preparing magnesium sulfate from sulfuric acid waste solution and a method thereof. The invention employs sulfuric acid waste solution containing hydrogen peroxide as the principal raw material. A reactor is used to remove hydrogen peroxide from the sulfuric acid waste solution, while a filtration device effectively eliminates impurities, thereby yielding high-purity magnesium sulfate crystals. The crystallization is carried out in a continuous manner, which shortens production time, enhances treatment efficiency of sulfuric acid waste solution, conforms to the principles of the circular economy, and achieves the goals of energy conservation and carbon reduction.

To accomplish the foregoing objective, the present invention provides a recovery system for preparing magnesium sulfate from sulfuric acid waste solution, comprising:
a reactor configured to remove hydrogen peroxide from the sulfuric acid waste solution and to promote a reaction between the sulfuric acid waste solution and a magnesium-based neutralizing agent, thereby generating a magnesium sulfate solution;
a crystallization device configured to cool the magnesium sulfate solution and to continuously crystallize magnesium sulfate, thereby obtaining magnesium sulfate crystals and a crystallization mother liquor thereof;
a dewatering device connected to the crystallization device and configured to remove the crystallization mother liquor, thereby obtaining the magnesium sulfate crystals; and
a drying device connected to the dewatering device and configured to obtain magnesium sulfate hydrates containing 0 to 7 molecules of crystalline water by controlling the drying temperature.

The present invention further provides a method for preparing magnesium sulfate from sulfuric acid waste solution by employing the above recovery system, the method comprising the steps of:
Step 1: Conveying the sulfuric acid waste solution containing hydrogen peroxide into the reactor, adding a magnesium-based neutralizing agent from a reactant supply tank into the reactor, continuously stirring at a constant temperature and speed, removing hydrogen peroxide, and catalyzing a reaction between the sulfuric acid waste solution and the magnesium-based neutralizing agent to generate the magnesium sulfate solution;
Step 2: Cooling the magnesium sulfate solution in the crystallization device to continuously precipitate the magnesium sulfate crystals; and
Step 3: Removing the crystallization mother liquor from the magnesium sulfate crystals by the dewatering device, and drying the magnesium sulfate crystals in the drying device at different drying temperatures to obtain the magnesium sulfate hydrates containing 0 to 7 molecules of crystalline water.

### BRIEF DESCRIPTION OF THE DRAWINGS

FIG. 1 is a schematic diagram of the recovery system according to a first embodiment of the present invention.

FIG. 2 is a schematic diagram of the recovery system according to a second embodiment of the present invention.

FIG. 3 is a schematic diagram of the recovery system according to a third embodiment of the present invention.

FIG. 4 is a schematic diagram of the recovery system according to a fourth embodiment of the present invention.

FIG. 5 is a flow chart illustrating the recovery method of the present invention.

### DETAILED DESCRIPTION OF THE PREFERRED EMBODIMENTS

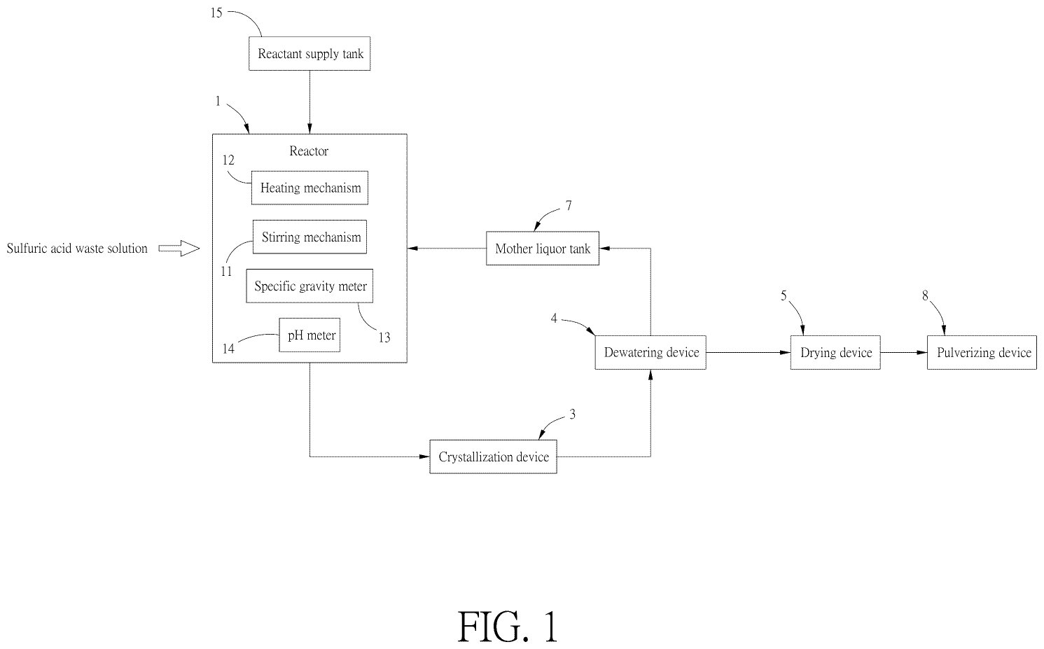

FIG. 1 illustrates a schematic diagram of a first embodiment of the recovery system for preparing magnesium sulfate from sulfuric acid waste solution provided by the present invention. As shown, the recovery system primarily comprises a reactor 1, a crystallization device 3, a dewatering device 4, and a drying device 5.

The reactor 1 is provided with a stirring mechanism 11 configured to agitate reactants within the reactor 1, and a heating mechanism 12 configured to heat and maintain a reaction temperature therein. In this embodiment, the reactor 1 may be connected to a sulfuric acid storage tank (not shown), the storage tank being configured to store and quantitatively deliver sulfuric acid waste solution into the reactor 1. Alternatively, the reactor 1 may be directly connected to a sulfuric acid discharge pipeline (not shown), wherein the pipeline conveys the sulfuric acid waste solution into the reactor 1 in a metered manner. The reactor 1 is further provided with a reactant supply tank 15, which is configured to supply a magnesium-based neutralizing agent into the reactor 1.

In further detail, the sulfuric acid waste solution recovered and utilized in the present invention is derived from waste solutions generated by the semiconductor manufacturing industry. The sulfuric acid waste solution typically contains sulfuric acid and hydrogen peroxide (H₂O₂). Since hydrogen peroxide interferes with the subsequent magnesium sulfate production process, it must be removed to minimize the formation of by-products. In practical operation, taking advantage of the propensity of hydrogen peroxide to thermally decompose, the magnesium-based neutralizing agent, in an amount accounting for 0.1% to 10% of the weight of the sulfuric acid waste solution, is first introduced into the reactor 1. Heating and stirring promote thermal decomposition of the hydrogen peroxide. Residual hydrogen peroxide levels are monitored at predetermined intervals using hydrogen peroxide test paper to ensure complete removal. Thereafter, the magnesium-based neutralizing agent is continuously added to the reactor 1, while the heating mechanism 12 and the stirring mechanism 11 maintain constant temperature and uniform agitation, thereby catalyzing the reaction between the sulfuric acid waste solution and the magnesium-based neutralizing agent to generate a magnesium sulfate solution.

The reactor 1 is further equipped with a specific gravity meter 13 and a pH meter 14, which continuously monitor the specific gravity of the magnesium sulfate solution and the pH value of the reaction mixture. These measurements render the reaction process both visualized and data-driven, thereby enabling operators to monitor the progress of the reaction in real time.

To cool the magnesium sulfate solution and continuously crystallize magnesium sulfate crystals along with a crystallization mother liquor, the crystallization device 3 may be a continuous vacuum cooling crystallizer, a continuous heat-exchange crystallizer, or a shower cooling crystallizer. The crystallization process is represented by the following reaction: Mg²⁺+SO₄²⁻+nH₂O→MgSO₄·nH₂O (n=0 to 7). By controlling the cooling temperature, magnesium sulfate hydrates containing different numbers of crystalline water molecules can be obtained. In practical implementation, a cooling temperature of 20° C. to 67.5° C. is preferably employed to obtain magnesium sulfate hydrates containing 6 to 7 crystalline water molecules. By adjusting the subsequent drying temperature, hydrates containing different amounts of crystalline water can then be obtained. Alternatively, a cooling temperature of approximately 80° C. yields a magnesium sulfate hydrate containing one crystalline water molecule.

The crystallization device 3 may also be implemented as multiple continuous vacuum cooling crystallizers or continuous heat-exchange crystallizers connected in series, thereby enhancing the efficiency of cooling and crystallization of the magnesium sulfate solution. In practical operation, the crystallization device 3 is preferably a shower cooling crystallizer. By controlling the flow rate within the range of 1 ton per hour to 6 tons per hour, the magnesium sulfate solution is cooled and crystallized to form magnesium sulfate crystals, thereby achieving rapid continuous crystallization, reducing crystallization time, and lowering energy consumption.

The present invention may optionally include a buffer tank 6. In the first embodiment, the buffer tank 6 is not provided. Instead, the magnesium sulfate crystals discharged from the crystallization device 3 are conveyed directly to the dewatering device 4, where the crystallization mother liquor is removed to yield the magnesium sulfate crystals. The crystallization mother liquor removed by the dewatering device 4 is directed into a mother liquor tank 7. Because the crystallization mother liquor still contains free acid, it can be recycled as raw material back into the reactor 1 after dewatering, thereby improving the overall recovery and utilization rate of the sulfuric acid waste solution. The dewatering device 4 is preferably a centrifugal dewatering device to achieve rapid liquid-solid separation.

The drying device 5 is connected to the dewatering device 4. The magnesium sulfate crystals, after dewatering in the dewatering device 4, are transferred into the drying device 5, where magnesium sulfate hydrates containing 0 to 7 crystalline water molecules are obtained by controlling the drying temperature. The drying device 5 is preferably a multi-stage drying apparatus, such as a multi-stage vibrating fluidized-bed dryer or a multi-stage flash dryer. When the bed temperature is controlled between 40° C. and 55° C., excessive dehydration is avoided, and continuous drying for 6 to 8 hours yields magnesium sulfate heptahydrate (MgSO₄·7H₂O) as the final product. Alternatively, by maintaining the bed temperature between 70° C. and 80° C. and drying continuously for 5 to 8 hours, the magnesium sulfate heptahydrate (MgSO₄·7H₂O) is converted into magnesium sulfate trihydrate (MgSO₄·3H₂O). Further, by maintaining the bed temperature at not less than 200° C. for 8 to 10 hours, anhydrous magnesium sulfate (MgSO₄) can be obtained.

The magnesium sulfate hydrates containing 0 to 7 molecules of crystalline water (MgSO₄·nH₂O, n=0 to 7) obtained through the above treatment are pulverized by a pulverizing device 8 connected to the drying device 5 to achieve the particle size required for commercial sale. The pulverized product is then portioned and sealed by a packaging machine according to market specifications.

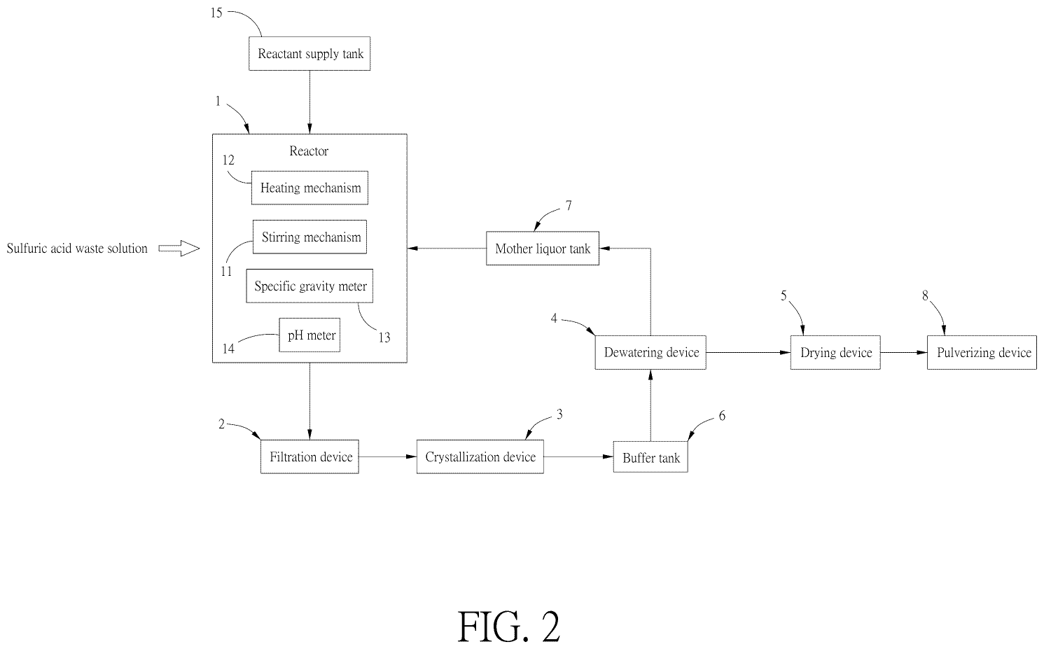

Referring to FIG. 2, a schematic diagram of a second embodiment of the recovery system for preparing magnesium sulfate from sulfuric acid waste solution is shown. The second embodiment represents an improvement upon the first embodiment. Unless otherwise specified, the remaining components and configurations are identical to those of the first embodiment and will not be repeated. The improvement resides in the provision of a filtration device 2 between the reactor 1 and the crystallization device 3, and a buffer tank 6 between the crystallization device 3 and the dewatering device 4. In practical operation, the crystallization device 3 may be implemented as a continuous vacuum cooling crystallizer, a continuous heat-exchange crystallizer, or a shower cooling crystallizer, preferably in combination with the buffer tank 6. As used herein, a shower cooling crystallizer refers to a cooling crystallizer comprising a shower-type liquid distributor.

As further shown in FIG. 2, the filtration device 2 is connected to the reactor 1. At this stage, the magnesium sulfate solution within the reactor 1 is conveyed into the filtration device 2, where solid impurities are separated from the solution. This reduces the introduction of impurities into the subsequent crystallization process and thereby improves the purity of the final product. The filtered magnesium sulfate solution is directed into the crystallization device 3, while the solid impurities are discharged through a solid discharge port. These solid impurities can be repurposed as cement additives, cement products, or brick and tile fillers. The filtration device 2 is preferably an acid-resistant plate-and-frame filter press.

The buffer tank 6 is connected to both the crystallization device 3 and the dewatering device 4. The crystallization device 3 discharges magnesium sulfate crystals and the crystallization mother liquor thereof into the buffer tank 6, where the mixture is allowed to stand. By exploiting the density difference between the magnesium sulfate crystals and the crystallization mother liquor, the magnesium sulfate crystals separate and precipitate at the bottom of the buffer tank 6. The settled magnesium sulfate crystals are subsequently conveyed via pipeline to the dewatering device 4, where the crystallization mother liquor is removed to yield the magnesium sulfate crystals. The separated crystallization mother liquor is directed to the mother liquor tank 7 thereafter.

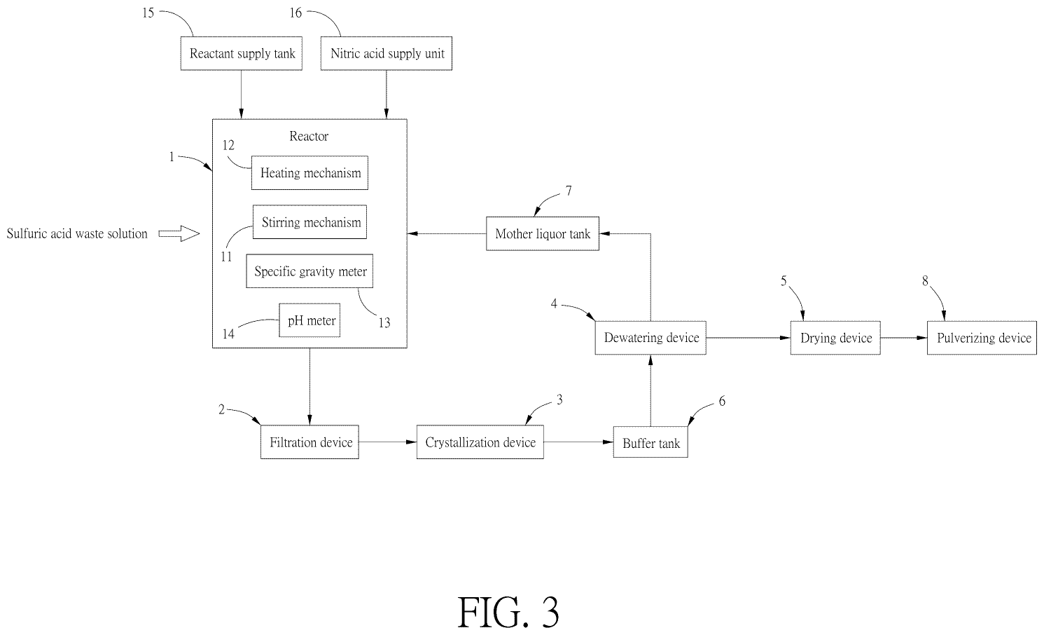

Referring to FIG. 3, a schematic diagram of a third embodiment of the recovery system is shown. The third embodiment represents an improvement upon the second embodiment. Unless otherwise specified, the remaining components and configurations are identical to those of the second embodiment and will not be repeated. The specific improvement resides in that the reactor 1 is further provided with a nitric acid supply unit 16, which introduces nitric acid into the reactor 1. By virtue of the strong oxidizing property of nitric acid, the nitric acid reacts with hydrogen peroxide to decompose the hydrogen peroxide, thereby achieving effective removal of hydrogen peroxide from the sulfuric acid waste solution.

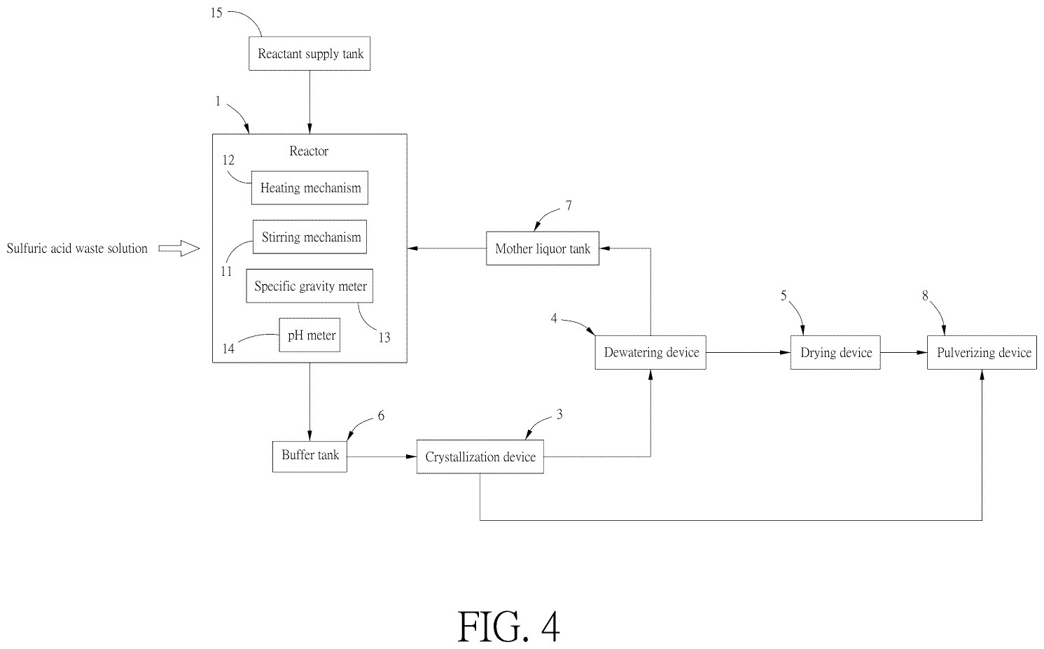

Referring to FIG. 4, a schematic diagram of a fourth embodiment of the recovery system is shown. The fourth embodiment represents an improvement upon the first embodiment. In addition to the components of the first embodiment, the recovery system further comprises a buffer tank 6, which is connected to both the reactor 1 and the crystallization device 3, while the crystallization device 3 is also connected to the pulverizing device 8. In this embodiment, the crystallization device 3 is preferably a shower cooling crystallizer. The buffer tank 6 not only allows the magnesium sulfate solution to stand so that insoluble impurities precipitate and separate, but also concentrates the magnesium sulfate solution, thereby facilitating rapid and continuous crystallization in the crystallization device 3.

Based on the recovery system composed of the foregoing components, a method for preparing magnesium sulfate from sulfuric acid waste solution is provided, comprising the following steps:
Step 1: Conveying the sulfuric acid waste solution containing hydrogen peroxide into the reactor 1, introducing a magnesium-based neutralizing agent from the reactant supply tank 15 into the reactor 1, continuously stirring at constant temperature and speed, removing hydrogen peroxide, and catalyzing a reaction between the sulfuric acid waste solution and the magnesium-based neutralizing agent to generate a magnesium sulfate solution;
Step 2: Cooling the magnesium sulfate solution in the crystallization device 3 to continuously precipitate magnesium sulfate crystals; and
Step 3: Removing the crystallization mother liquor from the magnesium sulfate crystals in the dewatering device 4, and drying the magnesium sulfate crystals in the drying device 5 at different drying temperatures to obtain magnesium sulfate hydrates containing 0 to 7 molecules of crystalline water.

In further detail, in Step 1, different methods may be employed to remove hydrogen peroxide by exploiting its instability under thermal or acidic conditions. One such method involves utilizing the chemical property of hydrogen peroxide to decompose under heat. Specifically, the magnesium-based neutralizing agent, in an amount accounting for 0.1% to 10% of the weight of the sulfuric acid waste solution, is first added into the reactor 1 through the reactant supply tank 15. The exothermic reaction between the sulfuric acid waste solution and the magnesium-based neutralizing agent, in combination with the heating action of the heating mechanism 12 of the reactor 1, promotes thermal decomposition of hydrogen peroxide. The decomposition is represented by the following chemical reaction formula:

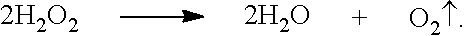

Residual hydrogen peroxide levels are measured at predetermined intervals using hydrogen peroxide test paper to ensure complete removal. Once hydrogen peroxide removal is confirmed, the magnesium-based neutralizing agent is continuously added to sustain the reaction.

A second method for removing hydrogen peroxide exploits its strong oxidizing property. In this method, concentrated nitric acid is added into the sulfuric acid waste solution within the reactor 1. The nitric acid reacts with hydrogen peroxide, decomposing it and thereby achieving removal of hydrogen peroxide from the sulfuric acid waste solution. The reaction is represented by the following chemical equation:

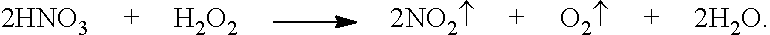

The nitric acid employed is concentrated nitric acid, added in an amount accounting for 3% to 10% of the weight of the sulfuric acid waste solution, and preferably 7% to 9% thereof. After removal of the hydrogen peroxide, the magnesium-based neutralizing agent is then introduced to initiate the neutralization reaction.

In further detail, the magnesium-based neutralizing agent added in Step 1 is a mixture of a magnesium-based compound and a solvent, blended in a weight ratio of 1:1 to 1:3. The magnesium-based compound comprises one or more of magnesium oxide (MgO), magnesium hydroxide (Mg(OH)₂), and magnesium carbonate (MgCO₃). The solvent comprises water, dewatered crystallization mother liquor, or a mixture thereof. Preferably, the magnesium-based compound and water are combined at a weight ratio of 1:2.

The magnesium-based neutralizing agent is metered and supplied in batches into the reactor 1 by the reactant supply tank 15. The temperature of the reactor 1 is controlled within a range of 50° C. to 90° C., and the stirring speed is maintained at 20 rpm to 90 rpm. Continuous stirring is performed for 15 to 45 minutes, thereby catalyzing the reaction between the sulfuric acid waste solution and the magnesium-based neutralizing agent. The principal reaction equations are as follows:

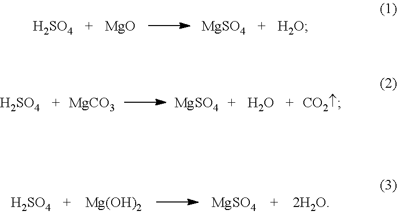

The sulfuric acid waste solution reacts with the magnesium-based neutralizing agent to form the magnesium sulfate solution. The reaction continues until the specific gravity of magnesium sulfate in the solution, as measured by the specific gravity meter 13, is within the range of 1.28 to 1.72, and the pH of the solution, as measured by the pH meter 14, is within the range of 5 to 8. At this stage, the sulfuric acid present in the sulfuric acid waste solution is essentially consumed, and the addition of the magnesium-based neutralizing agent is terminated.

In Step 2, the magnesium sulfate solution may first be directed through the filtration device 2 to remove solid impurities. The filtered solution is then cooled and continuously crystallized in the crystallization device 3 under conditions of 20° C. to 67.5° C. The magnesium sulfate crystals and the crystallization mother liquor may be transferred to the buffer tank 6, where they are allowed to stand for separation, after which the crystals are dewatered in the dewatering device 4. Alternatively, the magnesium sulfate solution may be conveyed directly to the dewatering device 4 to separate and obtain the magnesium sulfate crystals.

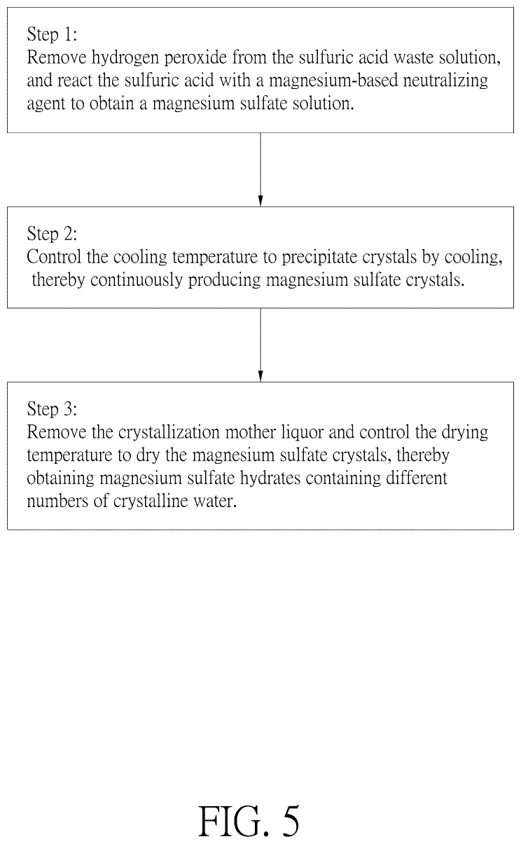

The process illustrated in FIG. 5, in combination with the recovery system shown in FIG. 2, further explains the technical content of the present invention.

### Raw Materials:

Sulfuric acid waste solution: Obtained from the semiconductor manufacturing industry, containing hydrogen peroxide (H₂O₂), with a sulfuric acid concentration of 75% and a hydrogen peroxide concentration of 5%; and

Magnesium-based neutralizing agent: A mixture of magnesium-based compounds and water in a weight ratio of 1:2, wherein the magnesium-based compounds include magnesium oxide, magnesium hydroxide, and magnesium carbonate.

### Reaction Steps:

Step 1: The sulfuric acid waste solution is quantitatively introduced into the reactor 1. The magnesium-based neutralizing agent is metered and added in batches from the reactant supply tank 15. The heating mechanism 12 raises the reactor temperature to 80° C. and maintains it constant, while the stirring mechanism 11 agitates the mixture at 70 rpm. The reaction is maintained at constant temperature and stirring speed. The residual hydrogen peroxide is periodically tested using hydrogen peroxide test paper until the specific gravity meter 13 measures the specific gravity of the magnesium sulfate solution at 1.66, and the pH meter 14 measures the pH at 7. At this point, the addition of the magnesium-based neutralizing agent is terminated. The reaction time is approximately 40 minutes.

Step 2: The magnesium sulfate solution is filtered through the filtration device 2, such as an acid-resistant plate-and-frame filter press, to remove solid impurities. The removed solid impurities are discharged and may be utilized as cement additives, cement products, or brick and tile filling materials. The filtered solution is cooled and crystallized in the crystallization device 3, which in this embodiment is a continuous heat-exchange crystallizer. At a crystallization temperature of 35° C., magnesium sulfate heptahydrate (MgSO₄·7H₂O) and its crystallization mother liquor are obtained, and then discharged into the buffer tank 6.

Step 3: The magnesium sulfate heptahydrate (MgSO₄·7H₂O) and its crystallization mother liquor are allowed to stand in the buffer tank 6 for liquid-solid separation, after which they are conveyed to the dewatering device 4 for centrifugal removal of the crystallization mother liquor, thereby obtaining magnesium sulfate heptahydrate crystals (MgSO₄·7H₂O). The crystallization mother liquor is diverted to the mother liquor tank 7 for storage. The magnesium sulfate heptahydrate crystals (MgSO₄·7H₂O) are then dried at 40° C. in a multi-stage vibrating fluidized-bed dryer to obtain the final magnesium sulfate heptahydrate (MgSO₄·7H₂O), which is pulverized and packaged as the finished product.

The magnesium sulfate heptahydrate prepared in the foregoing embodiment was inspected against feed-grade quality standards, and the results are presented in Table 1.

TABLE 1
Quality Test Results of Magnesium Sulfate Heptahydrate

| Quality Standard (feed grade) | Test Results |
|---|---|
| Main content: ≥99.5% | 99.6% |
| pH (5 W/V % Sol): 5 to 8 | 6.5 |
| Iron content (Fe): ≤0.0015% | Complies |
| Chlorine content (Cl): ≤0.015% | Complies |
| Heavy metals (Pb): ≤0.001% | Complies |
| Arsenic content (As): ≤0.0002% | Complies |
| Water-insoluble matter: ≤0.01% | Complies |
| Ignition loss: 48 to 52% | 49.3% |

As shown in Table 1, the magnesium sulfate heptahydrate produced using sulfuric acid waste solution derived from the semiconductor manufacturing industry and other industrial sources meets the feed additive specifications for magnesium sulfate. The process effectively removes impurities from the sulfuric acid waste solution, and the resulting product satisfies the quality requirements of multiple sectors, including industrial, feed, and agricultural applications.

Referring to FIG. 4, magnesium sulfate was prepared using both the recovery system provided by the fourth embodiment of the present invention and a conventional preparation system of the prior art. The specific processing sequence of the fourth embodiment is described below.

### Operation Steps:

Step 1: Convey the sulfuric acid waste solution containing hydrogen peroxide into the reactor 1. Introduce a magnesium-based neutralizing agent, accounting for 5% of the weight of the sulfuric acid waste solution, from the reactant supply tank 15, and heat the reactor 1. After hydrogen peroxide is removed, continue adding the magnesium-based neutralizing agent. Maintain the reaction at 75° C. and 72 rpm under constant stirring for 45 minutes. When the specific gravity of the magnesium sulfate solution reaches 1.29 and the pH reaches 7, stop adding the magnesium-based neutralizing agent to yield the magnesium sulfate solution.

Step 2: Cool the magnesium sulfate solution in the crystallization device 3, which is implemented as a shower cooling crystallizer, thereby continuously precipitating magnesium sulfate crystals.

Step 3: Convey the resulting magnesium sulfate crystals directly to the pulverizing device 8 to obtain crude magnesium sulfate crystals.

A detailed comparison between the conventional system and the recovery system of the present invention is summarized in Table 2.

TABLE 2
Comparison of Magnesium Sulfate Preparation Systems

| | System | | | |
|---|---|---|---|---|
| Steps | Prior art | | Present invention | |
| Sulfuric | Sulfuric acid waste solution | | (Same as prior art) | |
| acid source | containing ~5% H₂O₂; sulfuric | | | |
| | acid content 75%. | | | |
| Magnesium-based | Mg(OH)₂ and MgO mixed | | (Same as prior art) | |
| neutralizing | 2:1, then mixed with water 1:1 | | | |
| agent | by weight. | | | |
| Sample | Add sulfuric acid waste | | Add sulfuric acid waste | |
| preparation | solution to reaction kettle | | solution to reactor (0.5 h). | |
| | (0.5 h). | | | |
| Neutralization | Add neutralizing agent at | | Add neutralizing agent in two | |
| reaction | constant speed, stir 1-2 h (3-4 | | stages: initial 5% for H₂O₂ | |
| | h total). Dosage based on | | removal, then continuous | |
| | theoretical calculation; side | | addition. Reaction monitored by | |
| | reactions consume reagent. | | specific gravity meter and pH | |
| | | | meter until specific gravity = | |
| | | | 1.29, pH = 7. Total 2 h. | |
| Cooling | Water cooling crystallizer, | | Spray crystallizer, 3-4 h | |
| crystallization | 7-10 h | | | |
| Crystal | Centrifugal dewatering | | Magnesium sulfate crystals | |
| separation | (0.5-1 h) | | contain minimal mother liquor; | |
| | | | directly pulverized, no | |
| | | | dewatering required (0 h) | |
| Daily treatment | 50-100 tons/day | | 480-960 tons/day | |
| capacity | | | | |
| Differences | 1. | Dosage of neutralizing | 1. | Dosage and reaction time |
| | | agent often inaccurate due | | controlled via specific |
| | | to impurity consumption. | | gravity and pH monitoring. |
| | 2. | Crystallization is time- | 2. | Crystallization accelerated |
| | | consuming. | | by spray cooling, reducing time. |
| | 3. | Crystals and mother liquor cannot | 3. | Crystals obtained directly, |
| | | be separated simultaneously. | | saving separation time. |
| | 4. | Treatment is slow and | 4. | Process significantly |
| | | unsuitable for large-scale | | shortened, enabling rapid |
| | | processing. | | large-scale treatment. |

As demonstrated in Table 2, the recovery system of the fourth embodiment enables rapid preparation of crude magnesium sulfate crystals from sulfuric acid waste solution generated by the semiconductor manufacturing industry and other industrial sectors. The required processing time is substantially shorter than that of the prior art. The crude magnesium sulfate crystals can serve directly as raw materials, and through subsequent purification and refinement, magnesium sulfate of agricultural, industrial, feed, or food-grade quality can be obtained. Compared with existing technologies for recycling sulfuric acid waste solution, the present invention offers a substantially larger treatment capacity and higher efficiency, thus meeting industrial development demands.

In summary, the recovery system for preparing magnesium sulfate from sulfuric acid waste solution and the associated recovery method of the present invention provide the following technical advancements and advantages:

First, the system establishes control nodes that shorten reaction time. The reactor monitors the neutralization reaction with a specific gravity meter and a pH meter, thereby enabling precise control of reaction progress and duration, reducing unnecessary delays.

Second, the system reduces by-products and yields high-purity magnesium sulfate. Hydrogen peroxide is removed from the sulfuric acid waste solution either by thermal decomposition or by nitric acid oxidation. These treatments are simple, low-cost, and effective, enabling the preparation of magnesium sulfate hydrates of high purity that meet industrial standards.

Third, the system achieves high efficiency in waste solution treatment. Continuous crystallization, combined with controlled cooling, enables rapid precipitation of magnesium sulfate hydrates with various hydration states. The drying device further provides flexibility by controlling drying temperature to obtain hydrates with specific crystalline water content. As a result, production is both efficient and adaptable to different product specifications.

Fourth, the system satisfies the requirements of the circular economy while promoting energy conservation and carbon reduction. By using sulfuric acid waste solution as the raw material, and by employing heating, nitric acid oxidation, and filtration to remove impurities, the system produces magnesium sulfate crystals containing 0 to 7 crystalline water molecules. This approach not only mitigates environmental pollution and resource waste but also supplies magnesium sulfate products required by multiple industries, thereby fully supporting the principles of sustainable industrial development.

What is claimed is:

1. A recovery system for preparing magnesium sulfate from sulfuric acid waste solution, comprising:
a reactor configured to remove hydrogen peroxide from the sulfuric acid waste solution and to promote a reaction between the sulfuric acid waste solution and a magnesium-based neutralizing agent to generate a magnesium sulfate solution;
a crystallization device configured to cool the magnesium sulfate solution and continuously crystallize the magnesium sulfate solution to obtain magnesium sulfate crystals and a crystallization mother liquor;
a dewatering device connected to the crystallization device and configured to remove the crystallization mother liquor to obtain the magnesium sulfate crystals; and
a drying device connected to the dewatering device and configured to obtain magnesium sulfate hydrates containing 0 to 7 molecules of crystalline water by controlling a drying temperature.

2. The recovery system of claim 1, wherein the reactor comprises a heating mechanism and a stirring mechanism configured to heat and stir a solution within the reactor.

3. The recovery system of claim 1, wherein the reactor further comprises a nitric acid supply unit configured to introduce nitric acid into the reactor to promote removal of the hydrogen peroxide from the sulfuric acid waste solution.

4. The recovery system of claim 1, wherein the reactor further comprises a reactant supply tank configured to supply the magnesium-based neutralizing agent into the reactor.

5. The recovery system of claim 1, wherein the reactor further comprises a specific gravity meter and a pH meter configured to continuously monitor changes in specific gravity of the magnesium sulfate solution and pH value of the solution during the reaction process.

6. The recovery system of claim 1, further comprising a filtration device disposed between the reactor and the crystallization device and configured to filter the magnesium sulfate solution discharged from the reactor before entry into the crystallization device.

7. The recovery system of claim 6, wherein the filtration device is an acid-resistant plate-and-frame filter press.

8. The recovery system of claim 1, wherein the crystallization device is selected from the group consisting of a continuous vacuum cooling crystallizer, a continuous heat-exchange crystallizer, and a shower cooling crystallizer.

9. The recovery system of claim 1, further comprising a buffer tank connected to the crystallization device and to the dewatering device.

10. The recovery system of claim 1, further comprising a buffer tank connected to the reactor and the crystallization device, wherein the crystallization device is also connected to a pulverizing device, and wherein the crystallization device is a shower cooling crystallizer.

11. The recovery system of claim 1, further comprising a mother liquor tank connected to the dewatering device and to the reactor and configured to receive the crystallization mother liquor separated by the dewatering device and return the crystallization mother liquor to the reactor after dewatering.

12. The recovery system of claim 1, further comprising a pulverizing device connected to the drying device and configured to pulverize the dried magnesium sulfate hydrates.

13. A method for preparing magnesium sulfate from sulfuric acid waste solution using the recovery system of claim 1, comprising:
step 1: conveying the sulfuric acid waste solution containing hydrogen peroxide into the reactor, adding the magnesium-based neutralizing agent from the reactant supply tank into the reactor, continuously stirring at constant temperature and speed, removing the hydrogen peroxide, and catalyzing a reaction between the sulfuric acid waste solution and the magnesium-based neutralizing agent to generate the magnesium sulfate solution;
step 2: cooling the magnesium sulfate solution in the crystallization device to continuously precipitate the magnesium sulfate crystals; and
step 3: removing the crystallization mother liquor from the magnesium sulfate crystals in the dewatering device, and drying the magnesium sulfate crystals in the drying device at different drying temperatures to obtain the magnesium sulfate hydrates containing 0 to 7 molecules of crystalline water.

14. The method of claim 13, wherein in the step 1, the reactant supply tank first introduces the magnesium-based neutralizing agent in an amount accounting for 0.1% to 10% of the weight of the sulfuric acid waste solution into the reactor, and after the hydrogen peroxide is removed, continues supplying the magnesium-based neutralizing agent to react with the sulfuric acid waste solution.

15. The method of claim 13, wherein the magnesium-based neutralizing agent is a mixture of a magnesium-based compound and a solvent in a weight ratio of 1:1 to 1:3, the magnesium-based compound being one or more of magnesium oxide, magnesium hydroxide, and magnesium carbonate, and the solvent being water, dewatered crystallization mother liquor, or a mixture thereof.

16. The method of claim 13, wherein in the step 1, the reactor first introduces nitric acid from the nitric acid supply unit to promote removal of the hydrogen peroxide from the sulfuric acid waste solution, and thereafter introduces the magnesium-based neutralizing agent to react with the sulfuric acid waste solution, wherein the amount of nitric acid accounts for 3% to 10% of the weight of the sulfuric acid waste solution.

17. The method of claim 13, wherein in the step 1, the reaction temperature is maintained at 50° C. to 90° C., the stirring speed is maintained at 20 rpm to 90 rpm, and the solution is stirred continuously at constant temperature and speed for 15 minutes to 45 minutes.

18. The method of claim 13, wherein in the step 1, the magnesium-based neutralizing agent is added into the reactor in batches from the reactant supply tank until the specific gravity of the magnesium sulfate solution is between 1.28 and 1.72 and the pH value is between 5 and 8, at which point addition of the magnesium-based neutralizing agent is terminated.

19. The method of claim 13, wherein in the step 2, the magnesium sulfate solution is first filtered through the filtration device to remove solid impurities, and thereafter continuously crystallized in the crystallization device at a crystallization temperature of 20° C. to 67.5° C.
